(19) United States
(12) Patent Application Publication
(10) Pub. No.: US 2004/0188933 A1
(43) Pub. Date: Sep. 30, 2004

(54) Video game controller thumb pad

(76) Inventor: Paul Siciliano, Totowa, NJ (US)

Correspondence Address: Paul Gauer, 347 Franklin St, Bloomfield, NJ, 07003, US

(21) Appl. No.: 10/402,449

(22) Filed: Mar. 31, 2003

(51) Int. Cl. A63F 13/02

(52) U.S. Cl. 273/148 B

(57) ABSTRACT

A first video game controller thumb pad (110) removably positionable over a video game controller thumb key pad (14A) of a video game controller (14). The first video game controller thumb pad (110) having a circular first video game controller thumb pad top (112T) connected along an outside periphery to a top periphery of a first video game controller thumb pad side (112S). The first video game controller thumb pad top (112T) and first video game controller thumb pad side (112S) are manufactured from a soft resilient material. A second video game controller thumb pad (210) removably positionable over a video game controller thumb keypad (14A) of a video game controller (14). The first video game controller thumb pad (110) having a circular second video game controller thumb pad top (212T) connected along an outside periphery to a top periphery of a second video game controller thumb pad side (212S). The second video game controller thumb pad top (212T) further has a raised or indicia second video game controller thumb pad top cross (212TA) positioned thereon, the second video game controller thumb pad top (212T) and second video game controller thumb pad side (212S) are manufactured from a soft resilient material. A third video game controller thumb pad (310) removably positionable over a video game controller thumb key pad (14A) of a video game controller (14). The third video game controller thumb pad (310) having a square third video game controller thumb pad top (312T) connected along an outside periphery to a top periphery of a third video game controller thumb pad side (312S). The third video game controller thumb pad top (312T) further has a raised or indicia third video game controller thumb pad top cross (312TA) positioned thereon, the third video game controller thumb pad top (312T) and third video game controller thumb pad side (212S) are manufactured from a soft resilient material.

### BACKGROUND OF THE INVENTION

1. Field of the Invention

The present invention relates to a video game thumb pad. More particularly, the present invention relates to a ergodynamically designed video game thumb pad with padding.

2. Description of the Prior Art

Numerous innovations for a video game controller thumb pad have been provided in the prior art that are described as follows. Even though these innovations may be suitable for the specific individual purposes to which they address, they differ from the present invention as hereinafter contrasted.

In U.S. Pat. No. 5,976,018, invented by, Druckman, titled, Joystick adapter, an electronic game having a display screen for viewing of images generated by the internal circuitry of the game is provided. The game includes player controls for interactively playing the game with one of the controls being a multi-directional control key which can be used to control movements of an image on the screen for playing the game. The game has a joystick adapter which allows a joystick to be used in lieu of the control key for controlling image movement. Preferably, the joystick adapter includes a releasable snap-fit attachment between the joystick and control key to allow the joystick to be readily snapped into an operative position on the key for pivoting the key with the joystick. The game can also include mounting clips for receiving the joystick when it is not being used in a stored position attached to the game housing. The joystick can be configured in the form of an action figure to enhance its appeal to youngsters.

In U.S. Pat. No. 5,823,057, invented by, Hsien, titled, Joy stick structure, a joy stick structure for video game comprises a pressing plate having a central socket integrally provided thereunder, a body having a central through hole, a plurality of first spaces and a second space, a stick having a first end with a sphere thereof and a second end firmly received within the central socket of the pressing plate through the central through hole of the body and a plurality of transmission mechanisms securely received within the first spaces of the body. A positioning boss is formed integrally on the sphere and received within the second space of the body preventing unrequired movement of the stick. The sphere of the stick provides a smooth sliding effect.

In U.S. Pat. No. D396,495, invented by, Hirokane, titled, Game controller cover and in U.S. Pat. No. 5,643,087, invented by, Marcus, et al. Jul. 1, 1997, an input device including digital force feedback apparatus Abstract An input device for an interactive computer simulation or game is disclosed which includes a structure having at least two degrees-of-freedom which is moveable by a digit of a user to transmit input signal to a computer. At least one actuator connected to the moveable structure receives inputs from a computer and applies forces in the at least two degrees-of-freedom to the movable structure and thereby to the digit of the user. The actuator may include an electric motor and any of a variety of force transmission schemes including direct, cable, gear or belt drives. The applied forces are typically based on internal programming within the computer, events occurring in the simulation and movements of and forces applied to the movable structure by the operator. The input device of the invention thereby provides continuous interaction among motion of and forces applied by the movable structure, the events in the simulation and forces applied to and applied by the movable structure to enhance user enjoyment and performance.

In U.S. Pat. No. 5,501,458, invented by, Mallory, titled, Electronic game controller covers, an enhancing cover for electronic game controllers comprises a controller-specific shaped cover of an absorbent material and attachments for affixing said cover to such a controller. The cover wraps around the back, and in some embodiments, the sides of the controller. In the most preferred embodiment, the cover's position is retained by releasable fasteners, such as hook-and-loop fasteners, thereby allowing removal of the cover for washing. Alternately, the cover may be fixed in place by adhesive material with peel-off protective backing. The cover may be monolithic or comprised by multiple segments. The cover may be colored to vary the appearance of the game controller. The cover may also include a glow-in-the-dark substance so as to add to the controller's novelty and to make the controller easy-to-locate, even in the dark. The cover may have any of a variety of textures, formed to fit the users' hands, or formed to provide additional friction with the users' hands

The above patented inventions differ from the present invention because they fail to describe or claim at least one combination of features depicted in the present invention.

Numerous innovations for a video game controller thumb pad have been provided in the prior art that are adapted to be used. Even though these innovations may be suitable for the specific individual purposes to which they address, they would not be suitable for the purposes of the present invention as heretofore described.

### SUMMARY OF THE INVENTION

The present invention relates to a video game thumb pad. More particularly, the present invention relates to a ergodynamically designed video game thumb pad with padding.

The types of problems encountered in the prior art are video control buttons are uncomfortable on the thumbs when playing.

In the prior art, unsuccessful attempts to solve this problem were attempted namely: manufacturing softer buttons. However, the problem was solved by the present invention because the present invention is retrofitable over all pre-existing video game controllers.

Innovations within the prior art are rapidly being exploited in the field of video game controller accessories.

The present invention went contrary to the teaching of the art which describes and claims padded or softer buttons.

The present invention solved a long felt need for an easily retrofitable button or keyboard pad.

The present invention produced unexpected results namely: the game controller had a longer life of use.

A synergistic effect was produced utilizing the present invention due to the following facts and results from experimentation: there was a reduction in Carpel Tunnel Syndrome for persons utilizing the present invention.

Accordingly, it is an object of the present invention to provide a first video game controller thumb pad having a first video game controller thumb pad top, first video game controller thumb pad top base, first video game controller thumb pad side, first video game controller thumb lower member, and first video game controller thumb cushion.

More particularly, it is an object of the present invention to provide a first video game controller thumb pad top having a first video game controller thumb pad top left arrow, first video game controller thumb pad top right arrow, first video game controller thumb pad top up arrow, and first video game controller thumb pad top down arrow.

In keeping with these objects, and with others which will become apparent hereinafter, one feature of the present invention resides, briefly stated, in second video game controller thumb pad, second video game controller thumb pad top, second video game controller thumb pad top base, second video game controller thumb pad side, second video game controller thumb lower member, second video game controller thumb cushion.

When the third video game controller thumb pad is designed in accordance with the present invention, it has a third video game controller thumb pad top with a third video game controller thumb pad top cross, third video game controller thumb pad top base, third video game controller thumb pad side, third video game controller thumb lower member, and third video game controller thumb cushion.

The novel features which are considered characteristic for the invention are set forth in the appended claims. The invention itself, however, both as to its construction and its method of operation, together with additional objects and advantages thereof, will be best understood from the following description of the specific embodiments when read and understood in connection with the accompanying drawings.

### List of Reference Numerals Utilized in the Drawings

14—video game controller (14)

14A—video game controller thumb key pad (14A)

14AU—video game controller thumb key pad up button (14AU)

14AD—video game controller thumb key pad down button (14AD)

14AR—video game controller thumb key pad right button (14AR)

14AL—video game controller thumb key pad left button (14AL)

First Embodiment

110—first video game controller thumb pad (110)

112T—first video game controller thumb pad top (112T)

112TL—first video game controller thumb pad top left arrow (112TL)

112TR—first video game controller thumb pad top right arrow (112TR)

112TU—first video game controller thumb pad top up arrow (112TU)

112TD—first video game controller thumb pad top down arrow (112TD)

112B—first video game controller thumb pad top base (112B)

112S—first video game controller thumb pad side (112S)

112L—first video game controller thumb lower member (112L)

112A—first video game controller thumb cushion (112A)

Second Embodiment

210—first video game controller thumb pad (210)

212T—first video game controller thumb pad top (212T)

212TA—first video game controller thumb pad top cross (212TA)

212B—first video game controller thumb pad top base (not shown)

212S—first video game controller thumb pad side (212S)

212L—first video game controller thumb lower member (not shown)

212A—first video game controller thumb cushion (not shown)

Third Embodiment

310—first video game controller thumb pad (310)

312T—first video game controller thumb pad top (312T)

312TA—first video game controller thumb pad top cross (312TA)

312B—first video game controller thumb pad top base (not shown)

312S—first video game controller thumb pad side (312S)

312L—first video game controller thumb lower member (not shown)

312A—first video game controller thumb cushion (not shown)

### BRIEF DESCRIPTION OF THE DRAWINGS

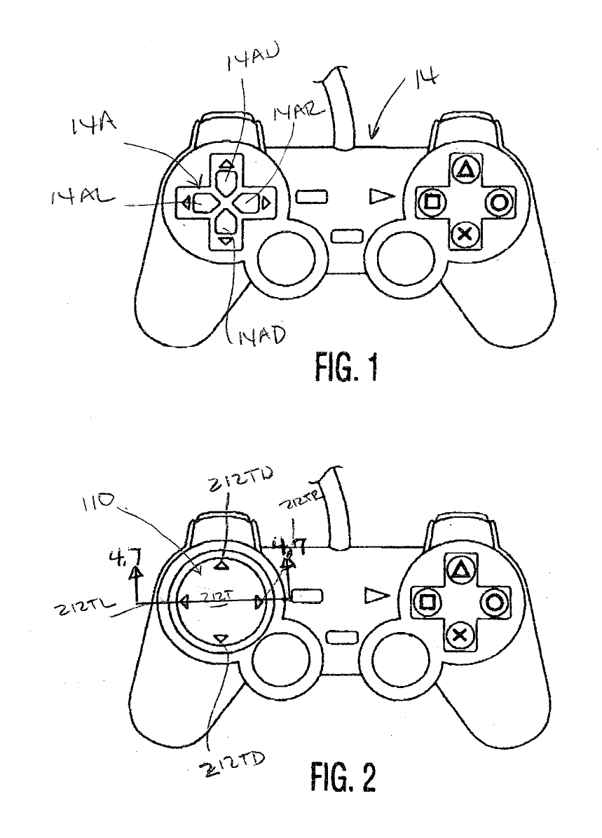

FIG. 1 is a top view of a video game controller (14).

FIG. 2 is a top view of a video game controller (14) with a first video game controller thumb pad (110) mounted on a video game controller thumb key pad (14A).

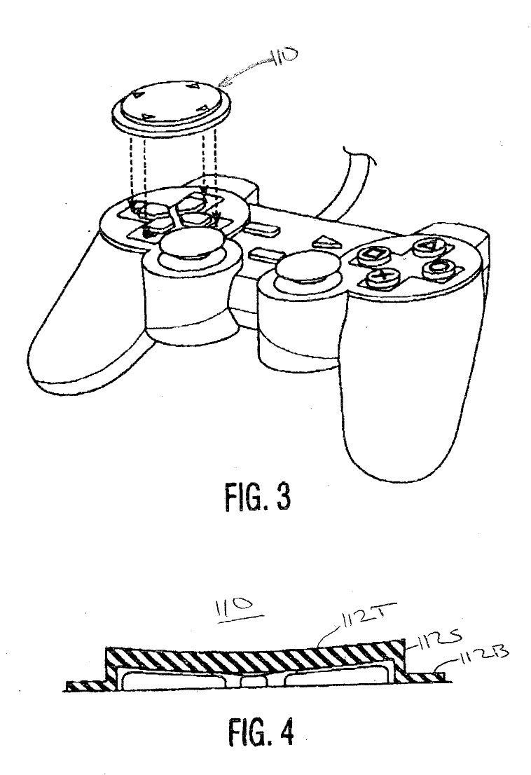

FIG. 3 is a top right rear perspective view of a video game controller (14) with a first video game controller thumb pad (110) being mounted on a video game controller thumb key pad (14A).

FIG. 4 is a cross sectional view along line 4-4 of FIG. 2 exhibiting a video game controller (14) with a first video game controller thumb pad (110) mounted on a video game controller thumb key pad (14A).

FIG. 5 is a top right rear perspective view of a video game controller (14) with a second video game controller thumb pad (210) being mounted on a video game controller thumb key pad (14A).

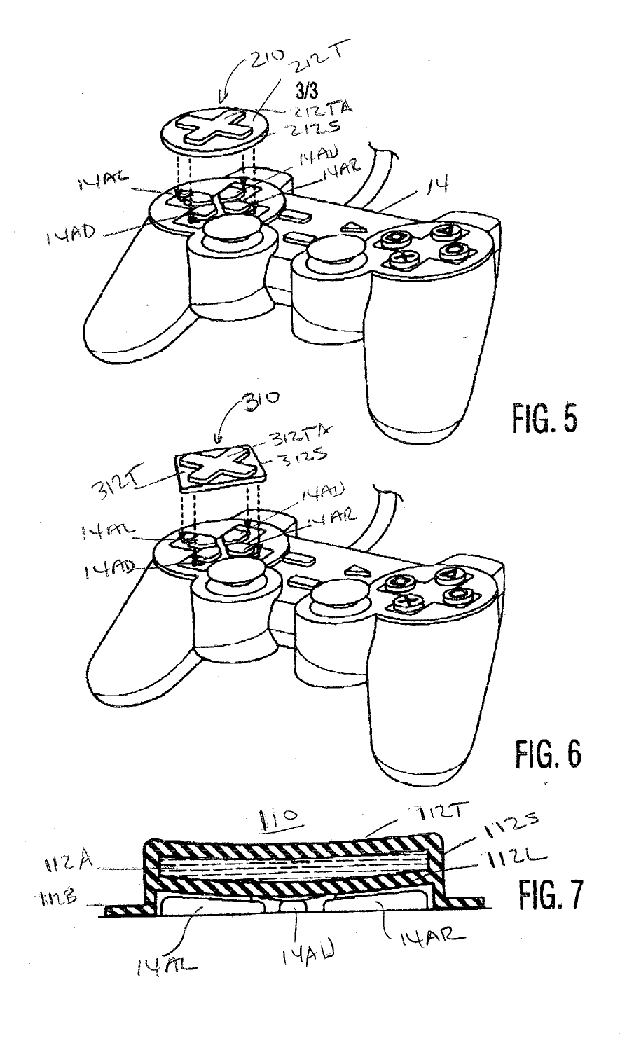

FIG. 6 is a top right rear perspective view of a video game controller (14) with a third video game controller thumb pad (310) being mounted on a video game controller thumb key pad (14A).

FIG. 7 is a cross sectional view along line 7-7 of FIG. 2 exhibiting a video game controller (14) with a first video game controller thumb pad (110) mounted on a video game controller thumb key pad (14A).

### DESCRIPTION OF THE PREFERRED EMBODIMENT

Firstly, referring to FIG. 1 which is a top view of a video game controller (14) and FIG. 2 which is a top view of a video game controller (14) with a first video game controller thumb pad (110) mounted on a video game controller thumb key pad (14A) and FIG. 3 which is a top right rear perspective view of a video game controller (14) with a first video game controller thumb pad (1 10) being mounted on a video game controller thumb key pad (14A) and FIG. 4 which is a cross sectional view along line 4-4 of FIG. 2 exhibiting a video game controller (14) with a first video game controller thumb pad (110) mounted on a video game controller thumb key pad (14A). The first video game controller thumb pad (110) removably positionable over a video game controller thumb key pad (14A) of a video game controller (14). The first video game controller thumb pad (110) comprises: a circular first video game controller thumb pad top (112T) connected along an outside periphery to a top periphery of a first video game controller thumb pad side (112S). The first video game controller thumb pad top (12T) and first video game controller thumb pad side (112S) are manufactured from a soft resilient material.

The first video game controller thumb pad (110) further comprises a first video game controller thumb pad top base (112B) securely affixed along an inner periphery to a lower periphery of the first video game controller thumb pad side (112S). The first video game controller thumb pad top (112T) further comprises a first video game controller thumb pad top left arrow (112TL) complimentary positioned over a video game controller thumb key pad left button (14AL) and a first video game controller thumb pad top right arrow (112TR) complimentary positioned over a video game controller thumb key pad right button (14AR) and a first video game controller thumb pad top up arrow (112TU) complimentary positioned over a video game controller thumb key pad up button (14AU) and a first video game controller thumb pad top down arrow (112TD) complimentary positioned over a video game controller thumb key pad down button (14AD).

Referring to FIG. 5 which is a top right rear perspective view of a video game controller (14) with a second video game controller thumb pad (210) being mounted on a video game controller thumb key pad (14A). A second video game controller thumb pad (210) removably positionable over a video game controller thumb key pad (14A) of a video game controller (14), the first video game controller thumb pad (110) comprises a circular second video game controller thumb pad top (212T) connected along an outside periphery to a top periphery of a second video game controller thumb pad side (212S). The second video game controller thumb pad top (212T) further comprises a raised or indicia second video game controller thumb pad top cross (212TA) positioned thereon. The second video game controller thumb pad top (212T) and second video game controller thumb pad side (212S) are manufactured from a soft resilient material. The second video game controller thumb pad (210) may optionally further comprise a second video game controller thumb pad top base (not shown) securely affixed along an inner periphery to a lower periphery of the second video game controller thumb pad side (212S).

Referring to FIG. 6 which is a top right rear perspective view of a video game controller (14) with a third video game controller thumb pad (310) being mounted on a video game controller thumb key pad (14A). The third video game controller thumb pad (310) removably positionable over a video game controller thumb key pad (14A) of a video game controller (14). The third video game controller thumb pad (310) comprises a square third video game controller thumb pad top (312T) connected along an outside periphery to a top periphery of a third video game controller thumb pad side (312S). The third video game controller thumb pad top (312T) further comprises a raised or indicia third video game controller thumb pad top cross (312TA) positioned thereon. The third video game controller thumb pad top (312T) and third video game controller thumb pad side (212S) are manufactured from a soft resilient material. The third video game controller thumb pad (210) further comprises a third video game controller thumb pad top base (not shown) securely affixed along an inner periphery to a lower periphery of the third video game controller thumb pad side (312S).

Lastly, referring to FIG. 7 which is a cross sectional view along line 7-7 of FIG. 2 exhibiting a video game controller (14) with a first video game controller thumb pad (110) mounted on a video game controller thumb key pad (14A). The first video game controller thumb pad (110) further comprises a first video game controller thumb lower member (112L) securely affixed along an outer periphery to an inner surface of the first video game controller thumb pad side (112S) below the first video game controller thumb pad top (12T) forming a pneumatic space therebetween. The space is filled with a first video game controller thumb cushion (112A).

The second video game controller thumb pad (210) further comprises a second video game controller thumb lower member (not shown) securely affixed along an outer periphery to an inner surface of the second video game controller thumb pad side (212S) below the second video game controller thumb pad top (212T) forming a pneumatic space therebetween. The space is filled with a second video game controller thumb cushion (not shown).

The third video game controller thumb pad (310) further comprises a third video game controller thumb lower member (not shown) securely affixed along an outer periphery to an inner surface of the third video game controller thumb pad side (312S) below the third video game controller thumb pad top (312T) forming a pneumatic space therebetween. The third video game controller thumb pad (310) wherein the space is filled with a third video game controller thumb cushion (not shown).

It will be understood that each of the elements described above, or two or more together, may also find a useful application in other types of constructions differing from the type described above.

While the invention has been illustrated and described as embodied in a video game controller thumb pad it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A first video game controller thumb pad (110) removably positionable over a video game controller thumb key pad (14A) of a video game controller (14), the first video game controller thumb pad (110) comprising:
A) a circular first video game controller thumb pad top (112T) connected along an outside periphery to a top periphery of a first video game controller thumb pad side (112S), the first video game controller thumb pad top (112T) and first video game controller thumb pad side (112S) are manufactured from a soft resilient material.

2. The first video game controller thumb pad (110) as described in claim 1, further comprises a first video game controller thumb pad top base (112B) securely affixed along an inner periphery to a lower periphery of the first video game controller thumb pad side (112S).

3. The first video game controller thumb pad (110) as described in claim 1, wherein the first video game controller thumb pad top (112T) further comprises a first video game controller thumb pad top left arrow (112TL), a first video game controller thumb pad top right arrow (112TR), a first video game controller thumb pad top up arrow (112TU), and a first video game controller thumb pad top down arrow (112TD).

4. The first video game controller thumb pad (110) as described in claim 1, further comprises a first video game controller thumb lower member (112L) securely affixed along an outer periphery to an inner surface of the first video game controller thumb pad side (112S) below the first video game controller thumb pad top (112T) forming a pneumatic space therebetween.

5. The first video game controller thumb pad (110) as described in claim 4, wherein the space is filled with a first video game controller thumb cushion (112A).

6. A second video game controller thumb pad (210) removably positionable over a video game controller thumb key pad (14A) of a video game controller (14), the first video game controller thumb pad (110) comprising:
A) a circular second video game controller thumb pad top (212T) connected along an outside periphery to a top periphery of a second video game controller thumb pad side (212S), the second video game controller thumb pad top (212T) further comprises a raised or indicia second video game controller thumb pad top cross (212TA) positioned thereon, the second video game controller thumb pad top (212T) and second video game controller thumb pad side (212S) are manufactured from a soft resilient material.

7. The second video game controller thumb pad (210) as described in claim 6, further comprises a second video game controller thumb pad top base securely affixed along an inner periphery to a lower periphery of the second video game controller thumb pad side (212S).

8. The second video game controller thumb pad (210) as described in claim 6, further comprises a second video game controller thumb lower member securely affixed along an outer periphery to an inner surface of the second video game controller thumb pad side (212S) below the second video game controller thumb pad top (212T) forming a pneumatic space therebetween.

9. The second video game controller thumb pad (210) as described in claim 8, wherein the space is filled with a second video game controller thumb cushion.

10. A third video game controller thumb pad (310) removably positionable over a video game controller thumb key pad (14A) of a video game controller (14), the third video game controller thumb pad (310) comprising:
A) a square third video game controller thumb pad top (312T) connected along an outside periphery to a top periphery of a third video game controller thumb pad side (312S), the third video game controller thumb pad top (312T) further comprises a raised or indicia third video game controller thumb pad top cross (312TA) positioned thereon, the third video game controller thumb pad top (312T) and third video game controller thumb pad side (212S) are manufactured from a soft resilient material.

11. The third video game controller thumb pad (210) as described in claim 10, further comprises a third video game controller thumb pad top base securely affixed along an inner periphery to a lower periphery of the third video game controller thumb pad side (312S).

12. The third video game controller thumb pad (310) as described in claim 11, further comprises a third video game controller thumb lower member securely affixed along an outer periphery to an inner surface of the third video game controller thumb pad side (312S) below the third video game controller thumb pad top (312T) forming a pneumatic space therebetween.

13. The third video game controller thumb pad (310) as described in claim 11, wherein the space is filled with a third video game controller thumb cushion.
